(19) United States
(12) Patent Application Publication
(10) Pub. No.: US 2007/0158535 A1
(43) Pub. Date: Jul. 12, 2007

(54) COLOR IMAGING USING MONOCHROME IMAGERS

(76) Inventor: Cory Watkins, Eden Prairie, MN (US)

Correspondence Address: DICKE BILLIG & CZAJA, PLLC;ATTN: CHRISTOPHER MCLAUGHLIN, 100 SOUTH FIFTH STREET, SUITE 2250, MINNEAPOLIS, MN, 55402, US

(21) Appl. No.: 11/622,537

(22) Filed: Jan. 12, 2007

Related U.S. Application Data
(60) Provisional application No. 60/758,522, filed on Jan. 12, 2006.

(51) Int. Cl. G01J 3/50

(52) U.S. Cl. 250/226

(57) ABSTRACT

A system for capturing color images using monochrome image sensors is herein disclosed. Differences in monochrome pixel intensity are correlated with color using known reflection/transmission ratios of a beam splitter.

### CROSS-REFERENCE TO RELATED APPLICATION

This application claims priority under 35 U.S.C. §119(e)(1) to U.S. Provisional Patent Application Ser. No. 60/758,522, filed Jan. 12, 2006, entitled “Color Imaging Using Monochrome Imagers”, and bearing Attorney Docket No. A126.190.101.

### BACKGROUND OF THE INVENTION

Standard, prior art imaging systems (cameras) often capture color images using a single imaging device with a color filter array of RGB (red/green/blue) filters. However, this arrangement causes a significant loss of spatial resolution. Other prior art imaging systems use an assembly of three imaging devices, each of which has its own respective red, green, or blue filter. Undifferentiated light is provided to the imaging devices by a triple beam splitter that may include a dichroic optical filter.

### BRIEF DESCRIPTION OF THE DRAWINGS

FIG. 1 is a schematic view of a camera having two monochrome imaging devices.

FIG. 2 is a graph showing one relationship between the reflection/transmission ratio of a beamsplitter as a function of the wavelength of light transmitted or reflected by the beamsplitter.

FIG. 3 schematically illustrates an example offset determination associated with the imaging devices of FIG. 1.

### DETAILED DESCRIPTION OF THE INVENTION

In the following detailed description of the invention, reference is made to the accompanying drawings that form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims and equivalents thereof.

In one embodiment, two substantially identical monochrome imagers 10, 12 are spatially aligned and affixed to the two output paths of a beam splitter 14. The pixels of the imagers 10, 12 are aligned across the beam splitter 14 in the X and Y directions (relative to the width and height of each imager 10, 12) and with respect to rotation to less than a fraction of a pixel error or thereabout. In one embodiment, the pixels of imagers 10, 12 are aligned to within about 1/10 of a pixel error. The beam splitter 14 has a specifically defined or known reflection/transmission ratio as a function of wavelength that imposes a difference in the pixel intensities reaching the two imagers, despite the fact that there is only a single pixel intensity value input to the beam splitter 14. Because the beam splitter 14 reflection/transmission ratio will unequally transmit light incident upon the beamsplitter 14 based on the light's wavelength, one of imagers 10 or 12 will receive more light than the remaining imager 10 or 12. Calibration is performed to determine the difference in imager response for each wavelength that is created by the beamsplitter.

In another embodiment, two substantially identical monochrome imagers 10, 12 are only generally aligned and secured to the two output paths of a beam splitter 14. In this embodiment, perfect physical alignment of the two imagers 10, 12 is not contemplated. Instead, patterns of known geometric properties are imaged by each imager 10, 12 and the pixel arrays of each imager 10, 12 are mapped, the one to the other through a comparison of the images captured by the respective imagers 10, 12. It is to be understood that where significant pixel-to-pixel alignment occurs, correction algorithms may be used to ensure that any offset between the respective pixel arrays is considered and appropriate correction is made. By way of example, in one embodiment pixel intensity values may be integrated or otherwise aggregated over a range of pixels to obtain an average or composite pixel intensity value that may be related to similar pixel intensity values from the opposing imager 10 or 12 during a calibration process and/or during actual use of the system.

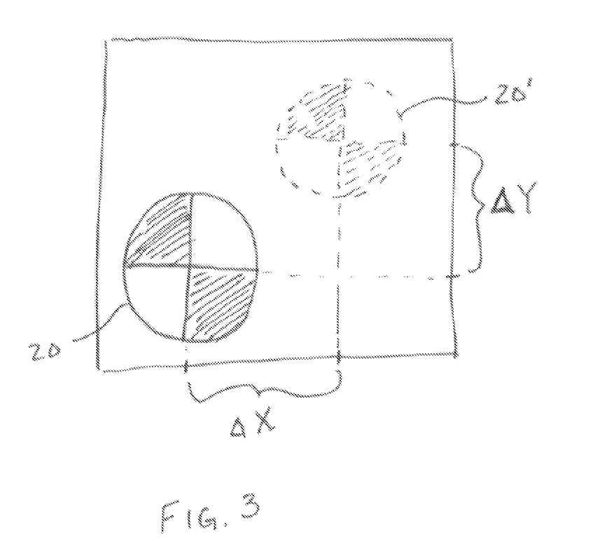

FIG. 3 illustrates schematically the calculation of an offset value as between the two imagers 10, 12. FIG. 3 shows an overlay of two images 20 and 20′ of a test pattern captured from imagers 10, 12, respectively. As can be seen, there is an offset, defined by terms ΔX and ΔY, between the images 20 and 20′. This offset is recorded during calibration and used to align the images during use.

In one embodiment, the imagers 10, 12 are area scan imagers such as, by way of example only, a CCD or CMOS device. In another embodiment, the imagers 10, 12 might be a line scan imaging device or a TDI imaging device.

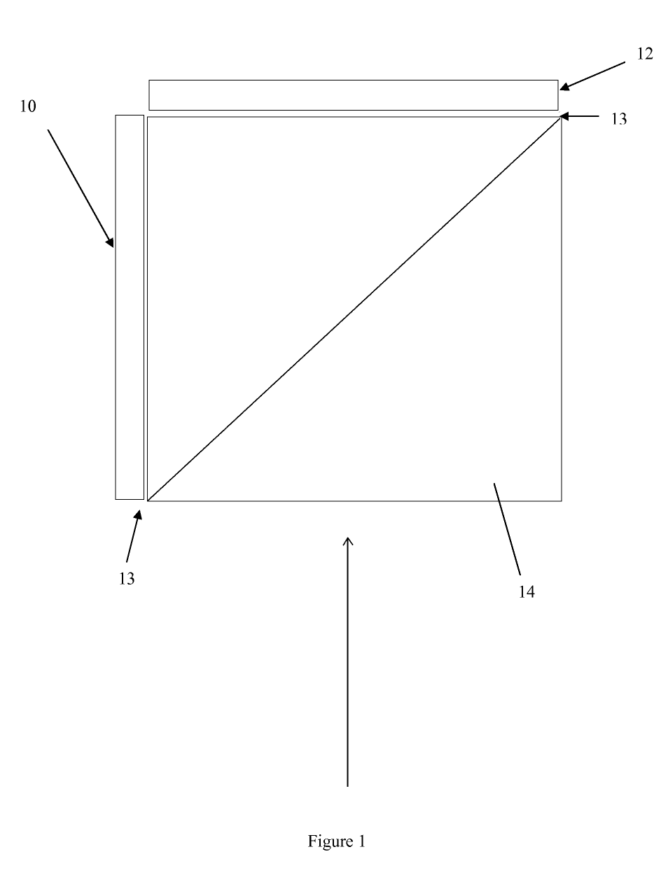

Note that in the embodiment illustrated in FIG. 1, the imagers 10, 12 are affixed directly to the beamsplitter 14 using an optically neutral adhesive 13. In some embodiments, a framework (not shown) may be utilized to securely hold the imagers 10, 12 in the required relationship to the beamsplitter 14 in a mechanical fashion. In other embodiments, a pellicle beamsplitter (not shown) may be used in lieu of the solid beam splitter shown in FIG. 1. As will be appreciated, any type of suitable beam splitter may be used. By way of example only, prismatic (with or without metallic or dielectric optical coatings) and thin-film beam splitters may be used in various embodiments.

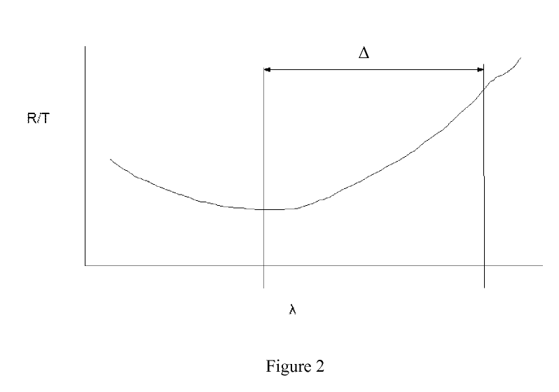

A generic curve that schematically illustrates reflection/transmission ratios (or coefficients) as a function of wavelength is shown in FIG. 2. In some embodiments, one or more optical or electronic filters are employed to limit data to the range of wavelengths (Δ) where there is a one-to-one relationship between the ratio or coefficient and the wavelength of the light incident on the beam splitter 14. In other embodiments, light sources used in conjunction with the camera are limited to outputting light within a given range of wavelengths using suitable filters and the like. In yet other embodiments, suitable optical filters are used on both the light sources and the imagers 10, 12.

The reflection/transmission ratio of the beam splitter is preferably specified such that for any given λ, there exists only one particular ratio of intensities, i.e. the relationship between wavelength and the reflection/transmission ratio is a one-to-one function. Discontinuities, minima or maxima in the reflection/transmission ratio v. wavelength curve may introduce indeterminacy in that a single reflection/transmission ratio may apply to more than one wavelength. Reflection/transmission ratio v. wavelength curves of this nature may still be used however, where image processing software may account for these discontinuities. In one embodiment, indeterminacy is resolved by looking to the colors of pixels adjacent and/or near the indeterminate pixel(s) and selecting a wavelength or color for the indeterminate pixel(s) that comports with the established reflection/transmission ratio v. wavelength relationship and which is closest in color to the surrounding pixels.

During operation, a camera such as that illustrated in FIG. 1 having two imagers 10, 12 coupled to a beamsplitter 14 receives a single light signal. This signal is in most instances light that is reflected from an object being imaged. In one embodiment, for each aligned pixel pair of the two imagers, the respective pixel intensities of the aligned pixel pair are averaged as shown by the formula:
I_{XY}=(I_{1XY}+I_{2XY})/2
where I_{1XY} is the measured pixel intensity of a first pixel of the aligned pixel pair and I_{2XY} is the measured pixel intensity of the remaining pixel of the aligned pixel pair.

Thereafter, a coefficient that is in one embodiment defined by the difference of the respective pixel intensities I_{1XY}, I_{2XY} divided by the average pixel intensity I_{XY} is calculated and plotted against known wavelength values as part of a calibration process. This calibration process relates wavelength to pixel intensity as follows:
λ_{XY}=f((I_{1XY-}I_{2XY})/I_{XY})

Note that where other coefficients, calibration procedures, or fitting methods or algorithms are used, this function may appear in a different form, but it is to be kept in mind that the basic relationship between wavelength and pixel intensity will be substantially the same for any given beamsplitter 14. One method of calibrating wavelength with respect to pixel intensity is to limit incident light input to the camera to a particular wavelength or narrow range of wavelengths and then measure pixel intensity in the pixel pairs of the respective imagers 10, 12. Another method of calibrating wavelength with respect to pixel intensity is to use a standard light source and direct the camera to capture an image of a color target having a reflectance band that is substantially at or distributed around a known wavelength and then measure pixel intensity in the pixel pairs of the respective imagers 10, 12.

In one embodiment, a camera incorporating imagers 10, 12 and a beam splitter 14 may be used to inspect substrates at a high rate of speed as described in co-pending U.S. patent application entitled “Camera Module for an Optical Inspection System and Related Method of Use”, Ser. No. 11/179,019 filed on Jul. 11, 2005, hereby incorporated by reference. Successive images of individual fields of view of a substrate may be captured by the respective imagers 10, 12 as described in the incorporated patent application. Because each field of view of the substrate is captured using alternating imagers 10 or 12, the monochrome image capture rate of a camera incorporating two imagers 10, 12 may approach twice the image capture rate of the imagers 10, 12 individually. Thereafter, color images of all or only selected portions of the substrate are captured using the imagers 10, 12 in combination with one another as described herein. Monochrome and color images may then be used to inspect the substrate for defects. Accordingly, both high speed monochrome image capture and color image capture may be accomplished using the same apparatus.

### CONCLUSION

While various examples were provided above, the present invention is not limited to the specifics of the examples. In one basic embodiment, the present invention is characterized by the output (pixel intensity) from two monochrome (black and white) imaging devices being averaged (I_{XY}) and used to calculate a coefficient (λ_{XY}) that is calibrated against the actual wavelength of the light presented to the two monochrome imaging devices. Since beam splitters can and often do have a wavelength dependent operating characteristics, it is important to use a beam splitter that exhibits a one-to-one relationship between reflection and transmission or which can manipulated in some manner to exhibit a one-to-one relationship between reflection and transmission. It is to be kept in mind that the relationship between reflection and transmission for a given beamsplitter may not be linear, but over at least a given range of wavelengths, the relationship must be such that for each coefficient (λ_{XY}), there is only one wavelength value. In addition to providing color information from monochrome imagers, this invention may increase the usable dynamic range of sensor over a single imager since one imager will always be more sensitive to a particular wavelength while the other is less sensitive.

Although specific embodiments of the present invention have been illustrated and described herein, it will be appreciated by those of ordinary skill in the art that any arrangement that is calculated to achieve the same purpose may be substituted for the specific embodiments shown. Many adaptations of the invention will be apparent to those of ordinary skill in the art. Accordingly, this application is intended to cover any adaptations or variations of the invention. It is manifestly intended that this invention be limited only by the following claims and equivalents thereof.

Although the present invention has been described with reference to preferred embodiments, workers skilled in the art will recognize that changes can be made in form and detail without departing from the spirit and scope of the present invention.

What is claimed is:

1. A color imaging device comprising:
a pair of monochrome imaging devices spatially fixed in relation to one another and to a beam splitter such that an array of pixels on each of the pair of monochrome imaging devices are aligned with one another on a pixel-by-pixel basis, the beam splitter having a known wavelength specific reflection/transmission ratio such that for any given wavelength in a selected range of wavelengths, a difference in the intensity of light incident upon corresponding pixels in the respective arrays of pixels is indicative of a specific wavelength of light.

2. The color imaging device of claim 1 wherein the corresponding pixels in the respective arrays of pixels of each imaging device are aligned to within 1/10 of a pixel error.

3. The color imaging device of claim 1 wherein the beamsplitter is a prism.

4. The color imaging device of claim 1 wherein the beam splitter is a pellicle.

5. The color imaging device of claim 3 wherein the pair of imaging devices is adhered directly to the beam splitter.

6. The color imaging device of claim 1 wherein the beam splitter's reflectance/transmission ratio over a selected range of wavelengths gives a substantially one-to-one relationship.

7. A color imaging device comprising:
two monochrome imaging devices arranged in combination with a beam splitter such that the monochrome imaging devices are generally aligned with one another and receive a split beam of light from the beam splitter;
wherein the beam splitter is characterized by a reflectance/transmission ratio versus wavelength curve wherein for every wavelength in a given range of wavelengths there is a one to one relationship between an observed reflectance/transmission ratio and a wavelength.

8. The color imaging device of claim 7 wherein the two monochrome imaging devices are substantially aligned on a pixel-by-pixel basis.

9. The color imaging device of claim 7 wherein the positions of the pixels of the two monochrome imaging devices with respect to one another is mapped electronically.

10. A method of obtaining color imaging data from two monochrome imaging devices comprising:
arranging two monochrome imaging devices in combination with a beam splitter such that corresponding pixels of each of the two monochrome imaging devices are at least generally aligned with one another;
calculating a coefficient from the pixel intensity values derived from each of the two monochrome imaging devices for each pixel;
calibrating the coefficients derived from a plurality of pixels with respect to known color wavelengths such that a given coefficient will correspond to a given color wavelength; and
determining the color wavelength of pixels of unknown color by obtaining pixel intensity data from the respective monochrome imaging devices, deriving coefficients from the pixel intensity data and looking up the appropriate color wavelength from calibrated coefficient/color wavelength data.

11. The method of obtaining color imaging data from two monochrome imaging devices of claim 10 further comprising aligning the two monochrome imaging devices to within a sub-pixel error.

12. The method of obtaining color imaging data from two monochrome imaging devices of claim 10 further comprising aligning the two monochrome imaging devices to within 1/10^{th} of a pixel error.

13. The method of obtaining color imaging data from two monochrome imaging devices of claim 10 further comprising mapping the relative positions of the individual pixels of the respective monochrome imaging devices to permit the calculation of coefficients.

14. The method of obtaining color imaging data from two monochrome imaging devices of claim 10 wherein the wavelength of light imaged by the monochrome imaging devices is limited to a selected range of wavelengths over which there is a substantially one-to-one relationship between the derived coefficients and specific wavelengths.

15. The method of obtaining color imaging data from two monochrome imaging devices of claim 10 wherein a wavelength is assigned to a pixel based on a derived coefficient based at least in part on a wavelength assigned to at least one other pixel.
